(19) United States
(12) Patent Application Publication
(10) Pub. No.: US 2006/0266087 A1
(43) Pub. Date: Nov. 30, 2006

(54) Locking device

(76) Inventors: Eric K. Hamilton, Fort Wayne, IN (US); Joseph S. Kromkowski, Granger, IN (US); Todd Schmutzler, Angola, IN (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 10/567,880

(22) PCT Filed: Nov. 12, 2004
(86) PCT No.: PCT/US04/37838

§ 371 Date: Feb. 9, 2006

(51) Int. Cl. E05B 65/00

(52) U.S. Cl. 70/91

(57) ABSTRACT

A locking device (10) includes a pair of end pieces (12, 14) and a locking member (16). One end piece (12) receives an end of the locking member, while the other end piece (14) is configured to receive the other end when the locking member is inserted through an object to lock the locking device to the object. The end pieces are formed together via a forming process, and are joined together via at least one frangible element or portion (18, 20) that is formed or molded during the forming process. The end pieces thus may be separated via breaking the frangible element or elements when it is desired to lock the locking device to an object. Multiple locking devices may be formed together and may be joined via frangible portions or elements such that a strip or series (22) of locking devices may be unitarily formed together.

### CROSS REFERENCE TO RELATED APPLICATIONS

The present application claims benefit of U.S. provisional application, Ser. No. 60/521,745, filed Jun. 29, 2004, and is a continuation-in-part of U.S. design patent application Ser. No. 29/206,196, filed May 27, 2004, which are hereby incorporated herein by reference in their entireties.

### FIELD OF THE INVENTION

The present invention relates to locking devices for locking or sealing items, such as cargo containers or doors or the like, and, more particularly, to a locking device having opposite end pieces that secure to a rod or locking member extending between the end pieces and through a locking clasp or the like of the cargo container or door.

### BACKGROUND OF THE INVENTION

It is known in the art to provide a locking device for locking or sealing an item, such as cargo containers or doors or the like, in a closed or sealed state. The locking devices often include a pair of end pieces that connect to an end of a rod to secure the rod through the sealed item. The locking devices are often packaged with one end piece attached to one end of the rod, and the other end piece tied or packaged with the end piece—rod assembly. This typically requires additional packaging of the parts to ship the parts together as a unit. Also, in applications where the end pieces are labeled or marked with identification numbers or the like (often the same number or identification is applied to both end pieces so that it will be readily apparent if the locking device is tampered with and one or both end pieces are replaced), the matching end pieces must be sorted and combined or packaged together, which may require further processing of the components prior to packaging.

Therefore, there is a need in the art for a locking device that overcomes the shortcomings of the prior art.

### SUMMARY OF THE INVENTION

The present invention provides a locking device that has a pair of end pieces that are molded or formed together or joined together during a molding or forming process, such that the matching end pieces are joined together and thus do not have to be sorted or packaged in separate processes. The joined end pieces may be readily separated or broken apart when it is desired to use the locking device. One of the end pieces may be molded onto or connected to an end of a locking member or rod, while the other end piece may be joined to the first end piece and formed to receive the other end of the rod therein to lock the locking device to an item. Multiple sets or pairs of end pieces may be molded or formed together or joined together during a molding or forming process, such that a pair of end pieces of a particular locking device may be separated or broken from the strip of locking devices. The matching end pieces are thus formed together and remain joined together such that sorting of the end pieces is not required.

According to an aspect of the present invention, a locking device includes first and second end pieces or portions formed together via a forming process, and a substantially rigid locking member. The second end piece is joined to the first end piece via at least one frangible element. The first end piece is attached to one end of the locking member and the locking member extends from the first end piece. The second end piece is separable from the first end piece via breaking the frangible element or elements. The second end piece is configured to receive the other end of the locking member when separated from the first end piece to lock the locking device to an object.

The first and second end pieces may be molded together, with the frangible element comprising interconnected portions of the first and second end pieces. The first end piece may be molded around the end of the locking member. The second end piece may be molded around a locking element that is configured to receive and secure to the other end of the locking member.

Optionally, the first and second end pieces may be formed with a surface thereon for forming indicia to identify respective pairs of first and second end pieces. The surface may comprise a substantially flattened surface for printing or applying indicia thereon, and/or may comprise a roughened surface for printing or applying indicia thereon.

According to another aspect of the present invention, a method of forming and using at least one locking device includes providing a mold with a cavity. The cavity comprises first and second cavity portions interconnected together via at least one connecting cavity portion extending between the first and second cavity portions in the mold. At least one pair of end pieces is molded from a polymeric material disposed within the mold cavity. The pair of end pieces comprises first and second end pieces connected together via at least one frangible portion formed by the material disposed within the connecting cavity portion or portions. A locking member is provided, and one end of the locking member is attached to the first end piece. The second end piece is separated from the first end piece by breaking the frangible portion. The second end piece is attached to the other end of the locking member when the locking member is inserted through an item to be locked or sealed.

The locking member may be inserted partially within the first mold cavity, and the first end piece may be molded around the end of the locking member. Likewise, a locking element may be inserted at least partially within the second mold cavity and the second end piece may be molded around the locking element. The locking element may be configured to receive the other end of the locking member therein to secure the second end piece to the locking member.

Optionally, and desirably, the mold cavity comprises a series of pairs of first and second cavity portions, with the first or second cavity portion of one pair of cavity portions being interconnected with the first or second cavity portion of another pair of cavity portions via at least another connecting cavity portion. A series of pairs of first and second end pieces may be molded together via a molding process, whereby each pair of first and second end pieces is connected to at least one other adjacent pair via at least one frangible portion formed by the connecting cavity portion or portions. A locking member may be inserted partially within each of the first cavities, and the first end pieces may be molded around the inserted ends of the locking members. A pair of first and second end pieces may be separated from the strip or series of pairs to provide a single locking device for use.

According to another aspect of the present invention, a series of locking devices includes a series of pairs of end pieces formed together via a forming process, and a plurality of locking members. Each of the pair of end pieces comprises first and second end pieces joined together via at least one first frangible portion between the first and second end pieces. The first and/or second end piece of one pair of the series is joined to the first and/or second end piece of another pair of the series via at least one second frangible portion between the pairs of end pieces. The plurality of locking members are attached to respective ones of the first end pieces and extend from the end pieces. The pair of first and second end pieces and the respective locking member comprise a locking device. The locking devices are individually separable from the series via breaking of the second frangible portion or portions between the pairs of end pieces. The second end piece of the removed or separated locking device is separable from the first end piece and is configured to attach to the other end of the locking member when the locking member is inserted through an object to lock the locking device to the object.

Therefore, the present invention provides a locking device that has a pair of end pieces that are formed together via a single forming or molding process. The end pieces are joined together via one or more frangible elements that are formed during the forming or molding process of the end pieces. One or more pairs of end pieces may be formed or molded together to provide a strip or series of end pieces and locking devices joined together by the frangible elements. Each respective pair of end pieces may be readily separated from the strip of locking devices to provide a single locking device for use on a particular object. The end pieces of the separated locking device are readily separable from one another via breaking the frangible element or elements. The end pieces may be formed or molded around a locking member or rod and a locking element, such that the entire locking device is formed via the forming or molding process and is retained together or joined together, such that no additional ties or packaging or the like is needed to keep the respective end pieces of a particular locking device together and not mixed with other end pieces of other locking devices. Multiple end pieces and locking devices may be formed in this manner, such that each locking device is joined to the other locking devices, yet the respective end pieces are not mixed between the locking devices. The present invention thus maintains the end pieces of multiple locking devices joined or connected to the respective other end pieces so that no other ties or packaging or sorting is required before using the locking devices. The end pieces of each locking device may have identification numbers or characters or indicia formed or printed thereon or otherwise attached or applied thereto, such that the respective end pieces are correspondingly marked or identified.

These and other objects, advantages, purposes and features of the present invention will become apparent upon review of the following specification in conjunction with the drawings.

### BRIEF DESCRIPTION OF THE DRAWINGS

FIG. 1 is a perspective view of a locking device in accordance with the present invention, with a pair of end pieces joined together via frangible elements;

FIG. 2 is a perspective view of the locking device of FIG. 1, with the locking device in a locked orientation;

FIG. 3 is a perspective view of a series or strip of locking devices joined together in accordance with the present invention;

FIG. 4 is a top plan view of the strip of FIG. 3;

FIG. 5 is an end elevation of the strip of FIGS. 3 and 4;

FIG. 6 is an end elevation of the other end of the strip shown in FIG. 5;

FIG. 7 is a side elevation of the strip of FIGS. 3-6;

FIG. 8 is a sectional view of the strip taken along the line A-A in FIG. 4;

FIG. 9 is a sectional view of the strip taken along the line B-B in FIG. 4;

FIG. 10 is an enlarged view of the area C in FIG. 4;

FIG. 11 is an enlarged view of the section of FIG. 8;

FIG. 12 is an enlarged view of the area D in FIG. 9;

FIG. 13 is an enlarged view of the area E in FIG. 5;

FIG. 14 is an enlarged view of the area F in FIG. 6;

FIG. 15 is an enlarged view of the area G in FIG. 14;

FIG. 16 is another perspective view of the series or strip of locking devices of FIGS. 3-6;

FIG. 17 is a perspective view of another series or strip of locking devices in accordance with the present invention, with an identification element incorporated into one of the end pieces;

FIG. 18 is a perspective view of another series or strip of locking devices in accordance with the present invention;

FIG. 19 is a perspective view of another series or strip of locking devices in accordance with the present invention;

FIG. 20 is a perspective view of another series or strip of locking devices in accordance with the present invention;

FIG. 21 is a perspective view of another series or strip of locking devices in accordance with the present invention; and

FIG. 22 is a perspective view of another series or strip of locking devices in accordance with the present invention.

### DESCRIPTION OF THE PREFERRED EMBODIMENTS

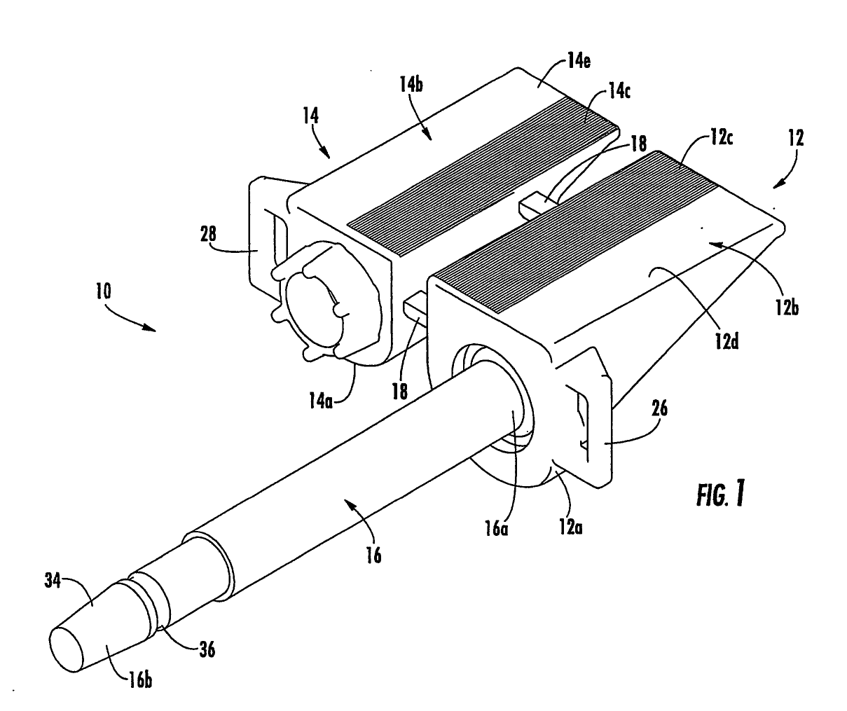

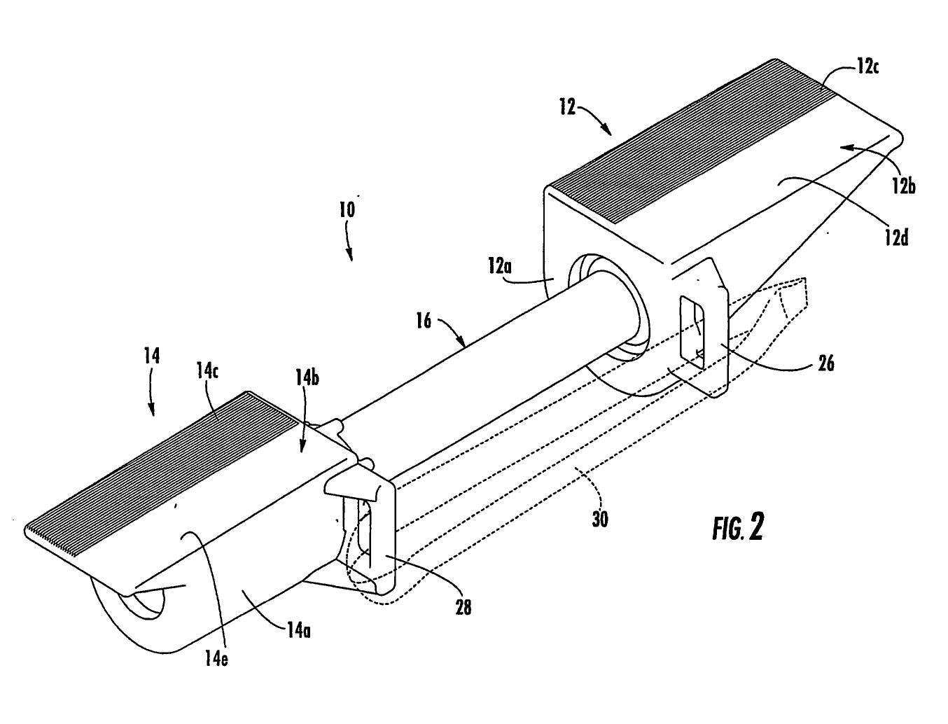

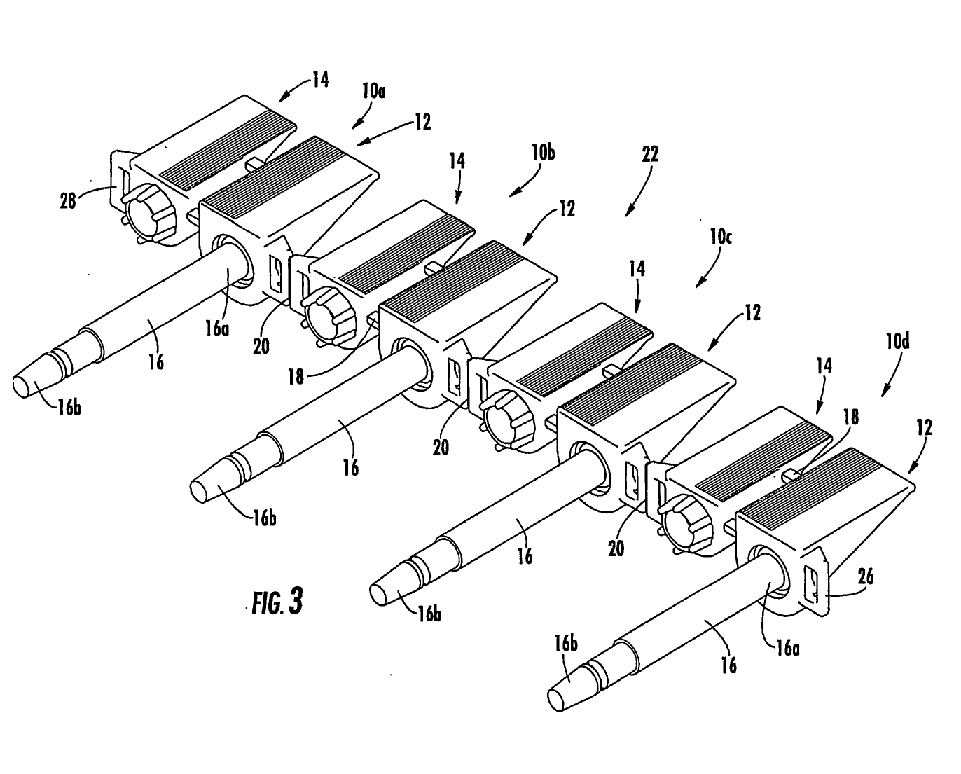

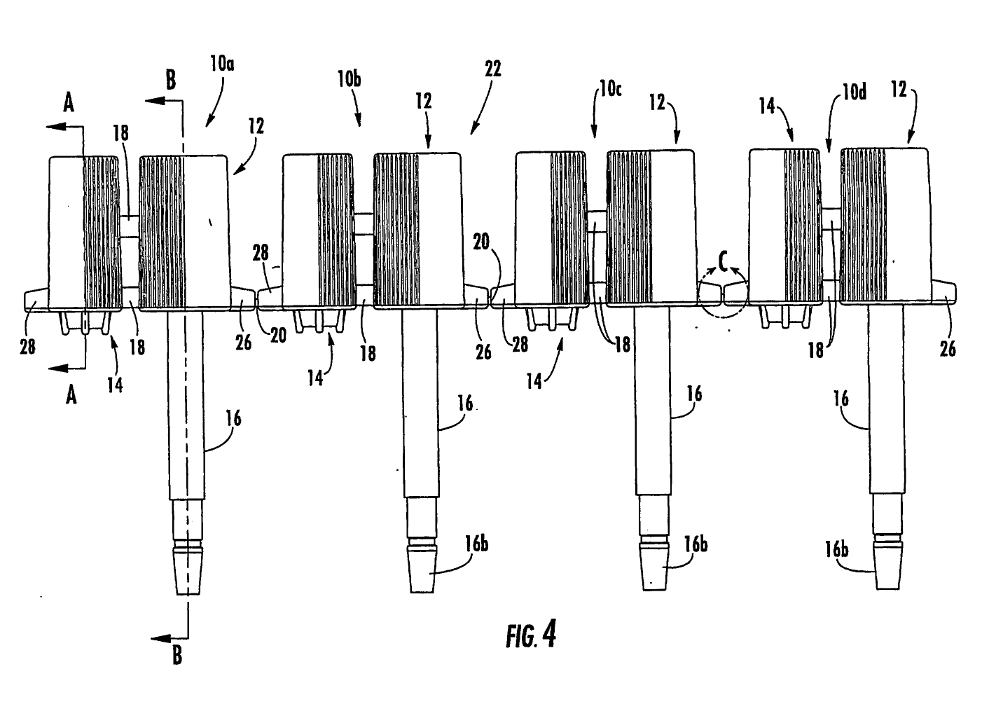

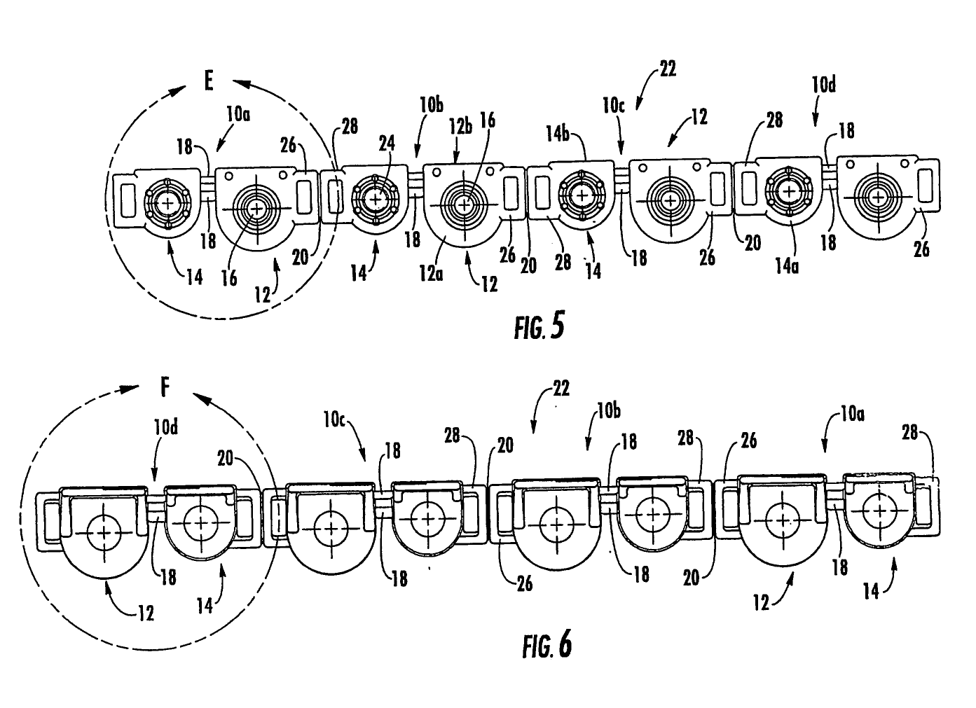

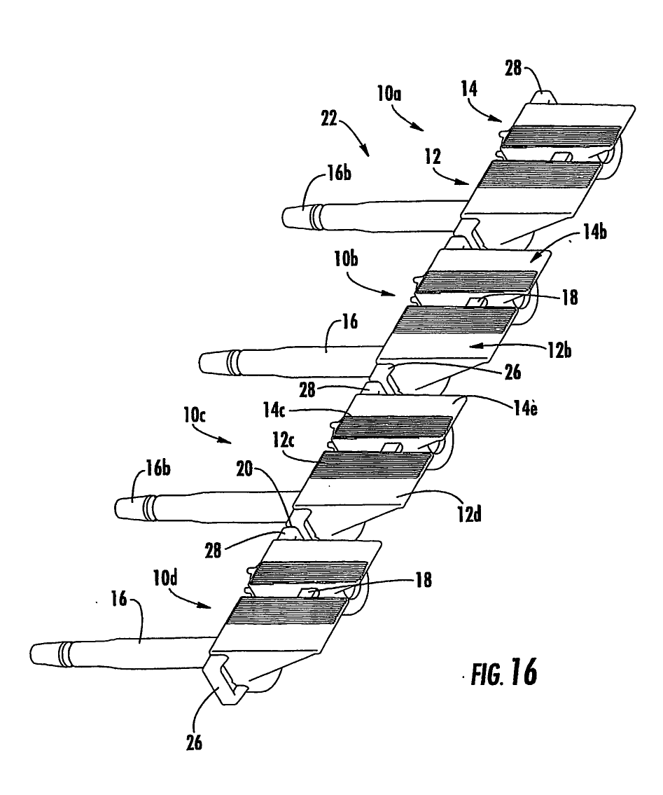

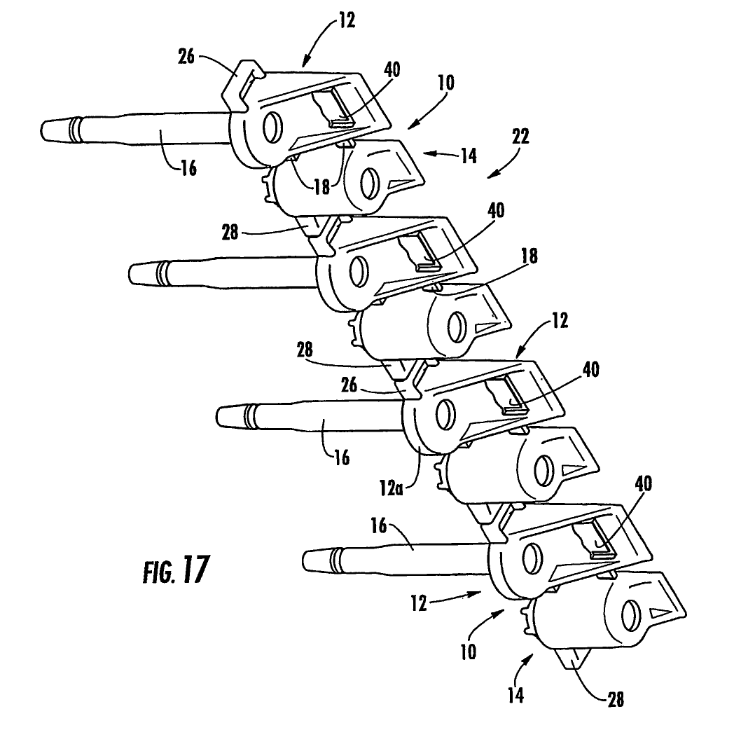

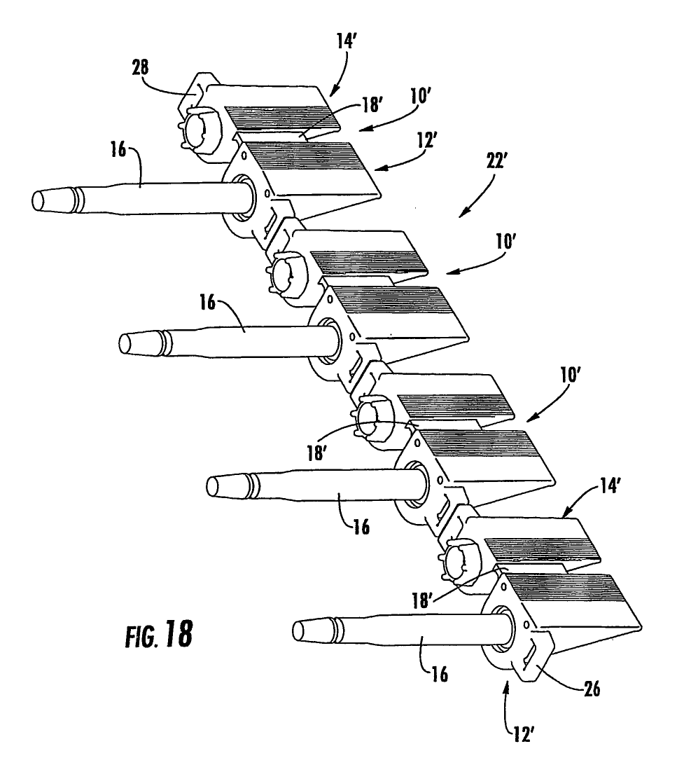

Referring now to the drawings and the illustrative embodiments depicted therein, a locking device 10 includes a pair of end pieces 12, 14 and a locking member or rod 16 (FIGS. 1 and 2). End piece 12 receives one end 16a of rod 16 therein, while end piece 14 is configured to receive the other end 16b of rod 16 therein when rod 16 is inserted through an object to lock the locking device to the object, which may be a door or cargo container or latch or the like. End pieces 12, 14 are formed via a forming process, such as by molding, such as injection molding or the like, and are joined together via at least one breakable or separable or frangible connecting element or portion 18 that is formed or molded during the forming process, as discussed below. The end pieces 12, 14 thus may be separated via breaking the frangible element 18 when it is desired to lock the locking device 10 to an object. Optionally, multiple end pieces 12, 14 and thus multiple locking devices 10 may be formed together and may be joined via breakable or separable or frangible portions or elements 20 such that a strip or series 22 of locking devices 10a-d (FIGS. 3-6 and 16) may be unitarily formed together, as also discussed below.

End piece 12 includes a generally cylindrical body portion 12a for receiving end 16a of rod 16 therein. End piece 12 also includes a generally flat or planar surface 12b extending therealong and on which identification numbers or letters or characters or other indicia may be formed or printed or applied, in order to provide identification of each end piece 12. Preferably, generally flat surface 12b includes a roughened surface portion 12c, which may be roughened or uneven and may have a plurality of ridges and grooves formed therealong (as best shown in FIGS. 14 and 15), and a generally smooth surface portion 12d. The roughened surface 12c provides a surface upon which the indicia may be printed, whereby the printed indicia will be difficult to alter or remove due to the uneven surface. In the illustrated embodiment, end 16a of rod 16 is inserted into a mold cavity and end piece 12 is molded therearound, such that rod 16 is fixedly secured to end piece 12 and extends therefrom, as discussed in detail below.

End piece 14 includes a generally cylindrical body portion 14a and a generally flat or planar surface 14b extending therealong and on which identification numbers or letters or characters or other indicia may be formed or printed or applied, in order to provide identification of each end piece 14. Preferably, generally flat surface 14b includes a roughened surface portion 14c, which may be roughened or uneven and may have a plurality of ridges and grooves 14d (FIG. 15) formed therealong, and a generally smooth surface portion 14e. The roughened surface 14c provides a surface upon which the indicia may be printed, whereby the printed indicia will be difficult to alter or remove due to the uneven surface. The identification indicia printed or formed on surface 14b of end piece 14 is preferably substantially identical to the identification indicia printed or formed on surface 12b of end piece 12, such that the end pieces are identifiable as being part of a single locking device.

Body portion 14a of end piece 14 is configured to receive end 16b of locking member 16 therein to lock the locking device 10 to an object (as shown in FIG. 2). In the illustrated embodiment, a locking element 24 (FIGS. 8 and 11) is inserted into a mold cavity and body portion 14a of end piece 14 is molded therearound, such that locking element 24 is fixedly secured at least partially within end piece 14. Locking element 24 may comprise a cylindrical element 24a defining a passageway at least partially therethrough with a lock ring 24b positioned within cylindrical element 24a, such as within a channel 24c formed within cylindrical element 24a. Lock ring 24b engages end 16b of rod 16 when rod 16 is partially inserted into locking element 24 to secure end piece 14 to rod 16, as discussed below.

In the illustrated embodiment, end piece 12 further includes a tab or loop 26 extending therefrom, while end piece 14 also includes a tab or loop 28 extending therefrom. Tabs 26, 28 are configured to receive an identification strip or secondary seal 30 (FIG. 2), such as a thin metal strip with identification numbers or letters or characters or other indicia thereon, therethrough, such that the identification strip 30 may be attached to end pieces 12, 14. Accordingly, in order to unlock locking device 10, the identification strip 30 would have to be broken or damaged or cut, which would then provide a visible indication that the locking device has been tampered with.

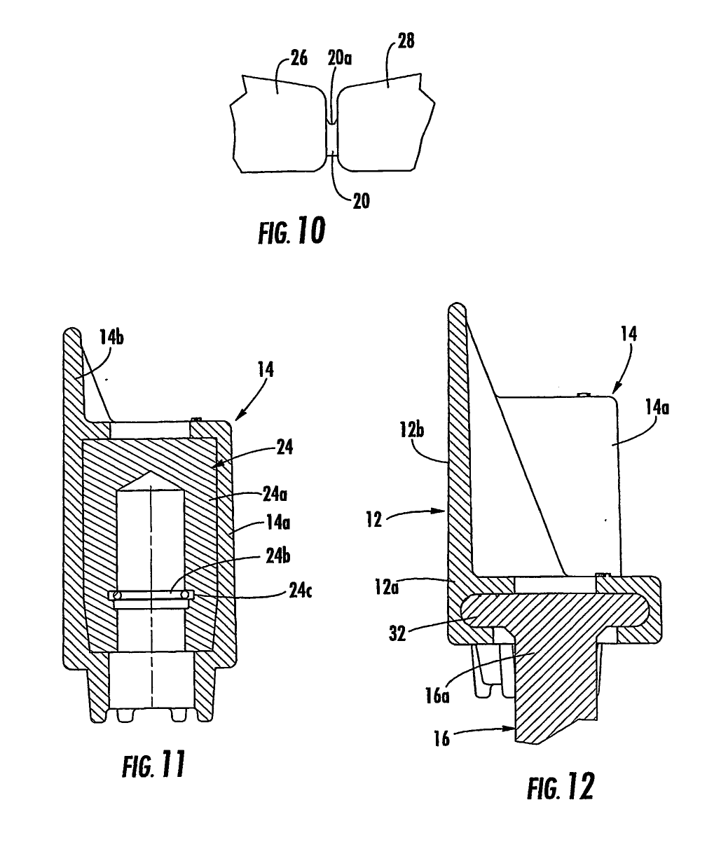

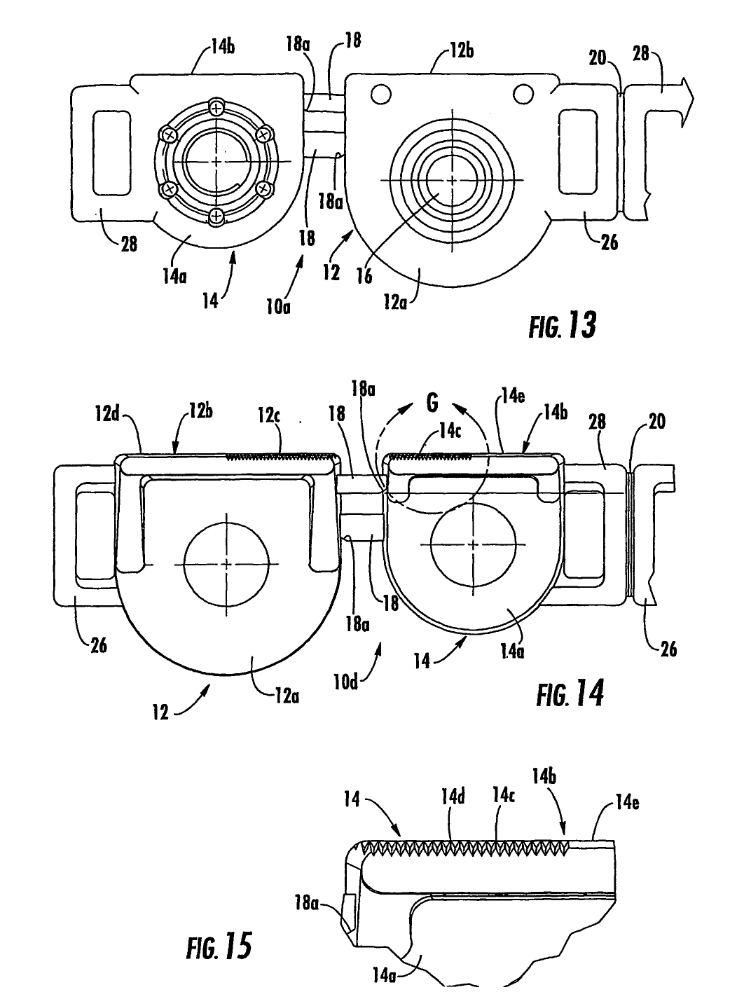

Locking member or rod 16 comprises a substantially rigid cylindrical rod formed of a metallic material (although the rod may be formed of other materials, without affecting the scope of the present invention). End 16a of rod 16 may include a base or disc portion 32 (FIGS. 9 and 12), which may be inserted into the mold cavity of end piece 12 to secure rod 16 to end piece 12. Optionally, disc portion 32 may have a non-circular shape or may have one or more extensions extending radially outward from the base, in order to non-rotatably secure rod 16 within end piece 12 when molded therein.

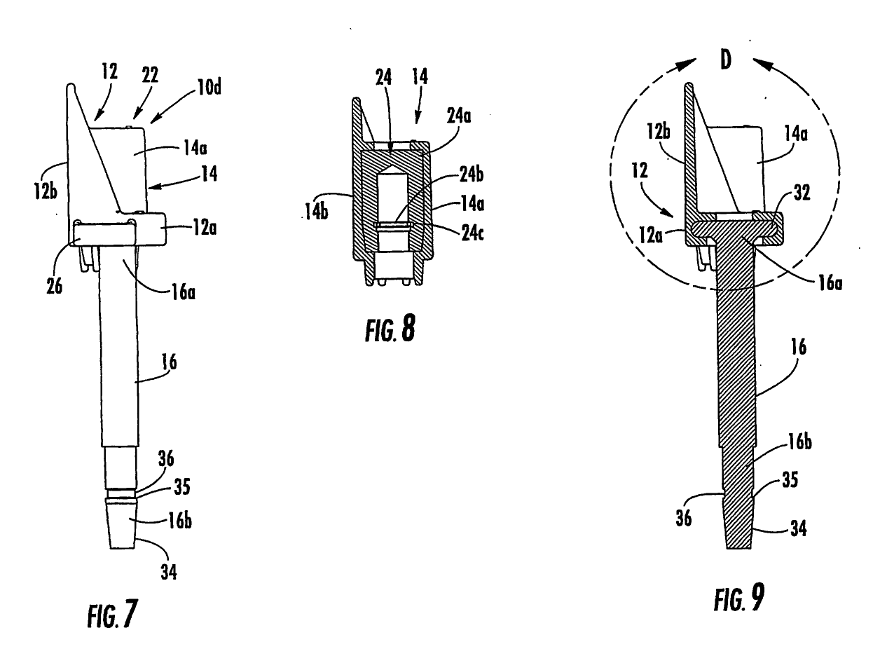

The opposite end 16b of rod 16 includes a tapered or ramped or conical end portion 34 with a narrowed section 36 at the end of the tapered end portion 34. The tapered end portion 34 is insertable into locking element 24 of end piece 14 and engages lock ring 24b. As the tapered end 34 is inserted further into locking element 24, lock ring 24b may slide along the ramped surface 34 and may expand to allow the tapered end portion to insert into locking element 24. As can be seen in FIG. 11, channel 24c is larger than the initial or normal size of lock ring 24b to allow for expansion of lock ring 24b as end 16b is inserted into locking element 24. When the lock ring 24b reaches the narrowed section 36, the lock ring 24b contracts to its normal size and limits or substantially precludes retraction of rod 16 from locking element 24 via engagement with the ledge or lip or annular surface 35 (FIGS. 7 and 9) at the end of the tapered section 34. End 16b of rod 16 thus may be inserted into end piece 14 and retained therein when it is desired to lock the locking device to an object.

End pieces 12, 14 may be integrally formed or molded together in a mold cavity. The mold cavity may include first and second cavity portions for forming the respective end pieces, and may also include one or more connecting cavity portions that interconnect the first and second cavity portions. When the end pieces are molded or formed, such as by disposing a polymeric or plastic material into the mold cavity, the molded end pieces are joined together via the frangible connecting elements 18 extending therebetween. The connecting cavity portions may be narrowed at one or both end pieces, such that the frangible connecting elements are narrowed at one or more locations therealong (such as shown at the ends 18a of the frangible elements 18 in FIGS. 13 and 14), in order to ease breaking of the frangible elements when it is desired to separate the end pieces from one another. Prior to molding the end pieces, the end 16a and disc portion 32 of rod 16 may be inserted into the cavity portion for the first end piece 12, while the locking element 24 may be inserted into the cavity portion for the second end piece 14, such that the end pieces are molded around the rod and locking element during the molding process. The entire locking device thus may be molded via a single molding process and may be retained together via the frangible elements, such that no other packaging or tie straps or the like are required to keep the end pieces together during shipping and handling of the locking device prior to actual use of the locking device.

As shown in FIGS. 3-6 and 16, a series or strip 22 of end pieces 12, 14 may be formed or molded via the single forming process. The mold cavity thus may include a plurality of pairs of first and second cavity portions, and may connect the adjacent cavity portions of the adjacent pairs via one or more connecting channels or cavity portions. Accordingly, when the mold cavity is filled with the desired or suitable material (such as a durable and strong polymeric material), the end pieces are formed and are joined together via the material filling the respective connecting channels or cavity portions. The molded end pieces thus are joined to the adjacent end pieces via the frangible connecting elements formed during the molding process. Because the end pieces are formed or molded together during a forming or molding process, and are thus retained together until it is desired to separate the end pieces from the strip and from each other, the identification numbers or characters or indicia may be applied to or printed on or formed on the surfaces of the corresponding end pieces of the strip without concern as to the matching end pieces being separated and mixed during shipping and handling of the locking devices and prior to their use at a particular object.

In the illustrated embodiment, the first end piece 12 is joined to the respective second end piece 14 via a pair of frangible connecting elements 18, while the adjacent pairs of end pieces are connected together via a frangible portion 20 extending along and between the outer end portions of the tabs 26, 28 of the adjacent end pieces. Each pair of respective end pieces 12, 14 (which may have the rod 16 and locking element 24 insert molded therein) are thus removably or separably joined together via frangible elements 18, while the adjacent locking devices 10a-d (each of which comprises a respective pair of end pieces 12, 14) are removably or separably joined together via frangible elements 20. Similar to frangible elements 18, frangible elements or portions 20 may be tapered or narrowed (such as at the center region 20a shown in FIG. 10) to ease breaking of the frangible element 20 to separate the pairs of end pieces from the strip 22. Multiple complete locking devices 10a-d thus may be provided in a single strip with no additional packaging or ties being required. Although shown as four locking devices formed or molded together, any number of locking devices may be formed or molded in the manner described herein, without affecting the scope of the present invention.

Although shown and described as separating respective pairs of end pieces by breaking the frangible elements 20 between the tabs, it is envisioned that the pairs may be separated from the strip by breaking the frangible elements 18 between the body portions of the adjacent end pieces, while the end pieces of a particular locking device may be separated for use by breaking the frangible element between the tabs, without affecting the scope of the present invention. Also, although shown as having the pairs of end pieces being separated by breaking a frangible element 20 at and between the tabs 26, 28 and separating the end pieces of a particular locking device by breaking the frangible elements 18 between the body portions of the end pieces, it is envisioned that other types of frangible connecting elements may be formed elsewhere between the end pieces (such as discussed below), without affecting the scope of the present invention.

The strip 22 of locking devices thus may be provided at an area and each locking device 10a-d may be readily removed from the strip 22 (by breaking the frangible element 20) for use at a particular object. The end pieces 12, 14 of the removed locking device may be readily separated by breaking the frangible element or elements 18 and the rod 16 may be inserted through the particular object to be locked or sealed. The removed or separated end piece 14 may then be secured to the end 16b of the rod 16 to lock or seal the locking device to the object. Optionally, the metallic tamper indicating strip or identification strip or secondary seal 30 may be routed through the tabs or loops 26, 28 and secured so that the strip cannot be readily removed from the locking device without damaging or destroying the strip and/or the end pieces of the locking device.

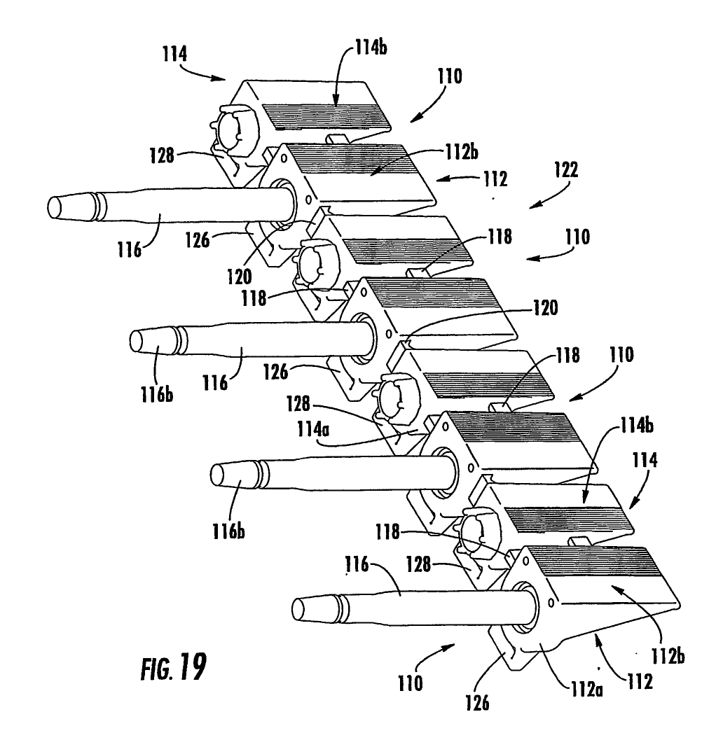

Optionally, one of the locking members or end pieces may include an identification chip or element embedded in or attached to or molded in or otherwise incorporated into or onto the end piece so that the end piece and locking device may be readily identified to ensure that the right locking device is on a particular item or cargo container or the like. Such an identification element provides or facilitates electronic tracking of the locking devices and provides a check to ensure that the locking device that was applied to a particular cargo container or item is still on the cargo container or item at a later date and, thus, provides a tracking and tamper resistant or tamper detection function. For example, and with reference to FIG. 17, an identification element, such as a radio frequency identification (RFID) element or chip or tag 40 may be attached to or embedded in or molded into or otherwise incorporated into or onto one or both of the end pieces, such as the end piece 12, so that the locking device may be readily identified. Such an identification element may use radio waves to automatically identify the end piece and the locking device, such as by storing a unique serial number (or other identifying information) or the like that identifies the particular end piece and locking device. The element or microchip may include or may be attached to an antenna that enables the chip to transmit the identification information to a reading device, which may convert the radio waves into digital information for automatically identifying the locking device via computers or the like, such that the locking devices may be automatically electronically tracked during use.

Such RFID chips or tags are known and may comprise a microchip with an antenna, and may be used in conjunction with an interrogator or reader with an antenna (which may be located at a shipping or receiving area or facility where the locked or sealed cargo items are shipped from or received at or the like). The reader may send out electromagnetic waves and the RFID tag antenna may be tuned to receive these waves. A passive RFID tag may draw power from the field created by the reader and may use the drawn power to power or enable or energize the microchip's circuits. The chip may then modulate the waves that the tag sends back to the reader, and the reader may convert the new waves into digital data for processing.

Although shown and described as including an RFID chip, clearly other means for identifying the end piece or end pieces or locking devices may be implemented, such as bar codes and the like, on or in one or more of the end pieces or locking rods of the locking devices, so as to provide a means for readily identifying the particular locking device on a particular cargo item or the like. In some applications, the RFID chip may be preferred because a scanner does not need to be directed at the chip to “read” the chip, as is typically required with barcode scanners and the like. The radio frequency identification doesn't require line of sight, so that the RFID tags may be automatically read as long as they are within range of the reader. The identification chip or element or the like may be attached to or embedded or molded in one or both of the end pieces of each locking device to provide the desired identification function for the locking devices.

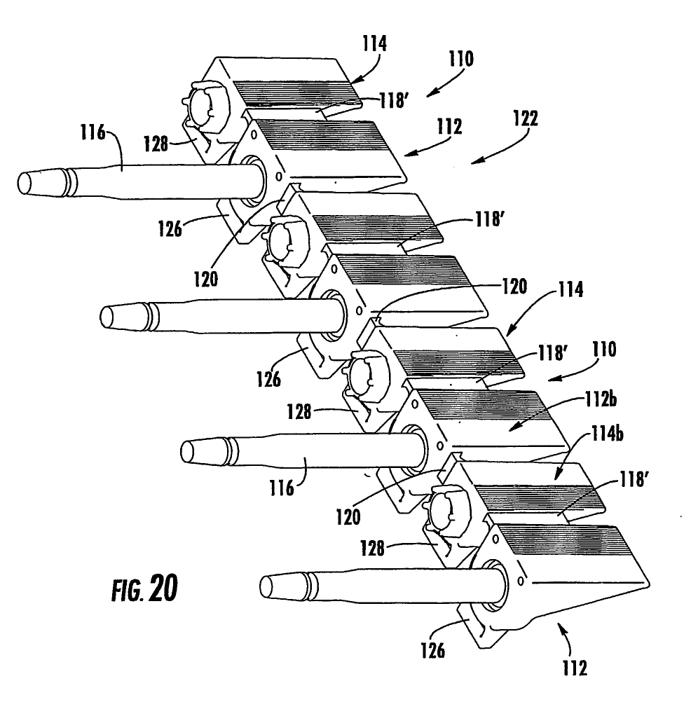

In the illustrated embodiment of FIGS. 1-16, the frangible connecting element or elements 18 comprise a pair of connecting elements extending between the end pieces or members 12 and 14. However, other forms of connecting elements with frangible portions may be implemented between the joined or formed end pieces, without affecting the scope of the present invention. For example, and with reference to FIG. 18, a series 22′ of locking devices 10′ may include end pieces or members 12′, 14′ that are joined together or formed together via a single elongated connecting element 18′ extending at least partially along and between the end pieces 12′, 14′. The end pieces 12′ , 14′ may otherwise be substantially similar to the end pieces 12, 14 described above, such that a detailed discussion of the end pieces and locking devices and strip will not be repeated herein. The similar elements of the end pieces are shown with the same reference numbers as used in FIGS. 1-16. Other forms of connecting elements with frangible portions or elements at one or both of the end pieces may be implemented, without affecting the scope of the present invention.

Optionally, it is envisioned that the end pieces or members of the locking devices may have a tab or loop for the secondary seal or identification strip extending from different portions or regions of the end pieces, such that the loops or tabs of adjacent end pieces are not joined together via a frangible portion or element. For example, and with reference to FIG. 19, a strip or series 122 of locking devices 110 may include end pieces or members 112, 114 with tabs or loops 126, 128 (respectively) extending from a lower or rearward portion of the end pieces 112, 114 (away from the identifying surfaces 112b, 114b). The end pieces 112, 114 of a locking device 110 may be joined together via connecting elements 118, while the end pieces 112, 114 of adjacent locking devices 110 may be joined together via connecting elements 120. The connecting elements 120, 118 may include frangible portions or elements to ease the separation of the individual locking devices from the strip and to ease the separation of the individual end pieces of a locking device from one another, such as described above. The locking devices 110 and strip 122 may otherwise be substantially similar to the locking devices and strips discussed above, such that a detailed discussion of the locking devices and strips will not be repeated herein. Suffice it to say that locking member or end piece 112 includes a locking rod 116 extending from the body portion 112a, while the body portion 114a of locking member or end piece 114 is configured to receive and retain an end 116b of locking rod 116 therein when the locking device 110 is secured to an item.

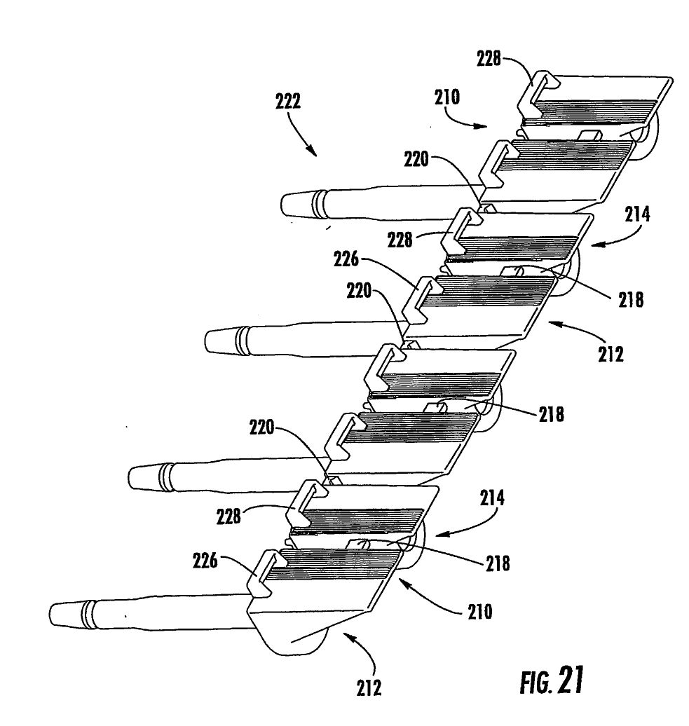

The tabs or loops may extend from the body portions 112a, 114a, and may extend in a direction generally opposite from the flat or identifying surfaces 112b, 114b. Because the loops or tabs 126, 128 are not positioned between the respective end pieces 112, 114, the end pieces of adjacent locking devices may be positioned closer together, such that a strip of locking devices may provide a greater number of locking devices for a given length of the strip (or may provide a desired number of locking devices in a shorter length strip). In the illustrated embodiment of FIG. 19, the connecting elements 118 comprise tabs or elements that are substantially similar to the connecting elements 18 discussed above. However, it is envisioned that the connecting elements may comprise other forms of connecting elements, such as an elongated connecting element 118′ (FIG. 20), such as similar to the connecting element 18′ discussed above, without affecting the scope of the present invention.

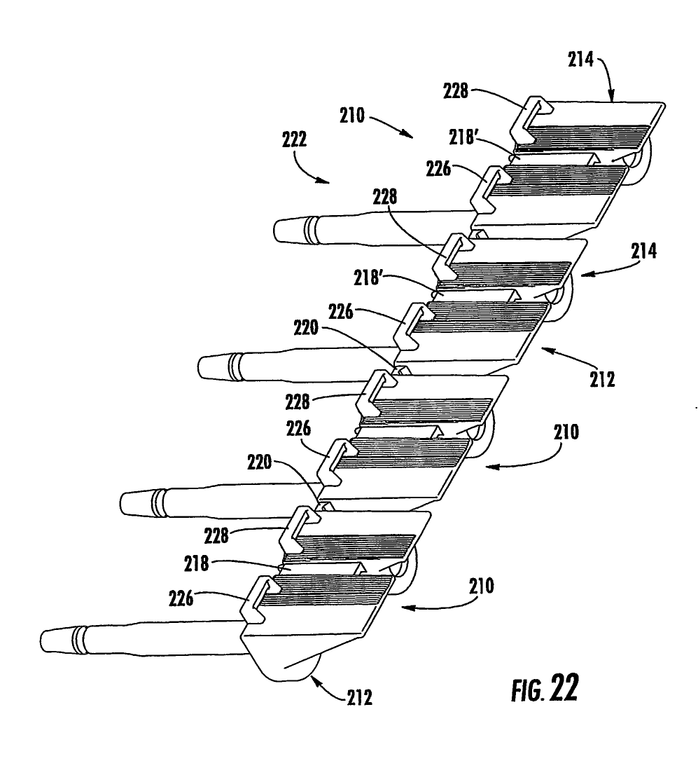

Optionally, and as shown in FIG. 21, a strip 222 of end pieces 212, 214 and locking devices 110 may include tabs or loops 226, 228 positioned elsewhere at the locking members or end pieces, such as at the flat or planar surfaces 212b, 214b of the respective end pieces 212, 214. The end pieces and locking devices and strip may be otherwise substantially similar to the end pieces and locking devices and strips discussed above, such that a detailed discussion of them will not be repeated herein. As can be seen with reference to FIGS. 21 and 22, the connecting elements 220 may be similar to connecting elements 120, discussed above, and the other connecting elements may comprise frangible connecting elements 218 (FIG. 21) similar to connecting elements 18, discussed above, or may comprise elongated connecting elements 218′ (FIG. 22) similar to connecting elements 18′ discussed above. Clearly, however, other forms of connecting elements and/or frangible elements may be implemented between the adjacent end pieces of a particular locking device or of adjacent locking devices, without affecting the scope of the present invention.

Therefore, the present invention provides a locking device that has a pair of end pieces that are formed together via a single forming or molding process. The end pieces are joined together via one or more frangible elements that are formed during the forming or molding process of the end pieces. The end pieces are readily separable from one another via breaking the frangible element or elements. The end pieces may be formed or molded around a locking member or rod and a locking element, such that the entire locking device is formed via the forming or molding process and is retained together or joined together, such that no additional ties or packaging or the like is needed to keep the respective end pieces of a particular locking device together and not mixed with other end pieces of other locking devices.

The present invention also provides a series or strip of a plurality of locking devices that are formed or molded together via a single forming or molding process. The respective end pieces of each locking device may be joined together via frangible connecting elements, while adjacent end pieces of adjacent pairs of end pieces may likewise be joined together via one or more frangible connecting elements. Each respective pair of end pieces may be readily separated from the strip of locking devices to provide a single locking device for use on a particular object. The end pieces of each locking device may have identification numbers or characters or indicia formed or printed thereon or other identifying items attached thereto, such that the respective end pieces are correspondingly marked or identified and/or the respective locking device is readily identifiable. Optionally, one or both end pieces may have an identification chip or element attached thereto or embedded or molded therein to provide an identification function for the particular end pieces and/or locking devices.

Changes and modifications to the specifically described embodiments may be carried out without departing from the principles of the present invention, which is intended to be limited only by the scope of the appended claims as interpreted according to the principles of patent law.

The embodiments of the invention in which an exclusive property or privilege is claimed are defined as follows:

1. A locking device comprising:
first and second end pieces formed together via a forming process, said second end piece being joined to said first end piece via at least one frangible element; and
a substantially rigid locking member, said first end piece being attached to one end of said locking member and said locking member extending from said first end piece, said second end piece being separable from said first end piece via breaking said at least one frangible element, said second end piece being configured to receive the other end of said locking member when separated from said first end piece to lock said locking device to an object.

2. The locking device of claim 1, wherein said first and second end pieces are molded together, said at least one frangible element comprising interconnected portions of said first and second end pieces.

3. The locking device of claim 2, wherein said first end piece is molded around said end of said locking member.

4. The locking device of claim 3, wherein said second end piece is molded around a locking element that is configured to receive and secure to the other end of said locking member.

5. The locking device of claim 1, wherein said first and second end pieces are formed with a surface thereon for forming indicia to identify respective pairs of first and second end pieces.

6. The locking device of claim 5, wherein said surface comprises a substantially planar surface for printing or applying indicia thereon.

7. The locking device of claim 6, wherein said surface comprises a roughened surface for printing or applying indicia thereon.

8. The locking device of claim 1, wherein multiple locking devices are formed together, each of said locking devices comprising first and second end pieces joined via at least one frangible element, and a substantially rigid locking member extending from said first end piece.

9. The locking device of claim 1, wherein at least one of said first and second end pieces includes an identification element for identifying said at least one of said first and second end pieces of said locking device.

10. The locking device of claim 9, wherein said identification element comprises a radio frequency identification chip.

11. The locking device of claim 1, wherein said first and second end pieces include first and second tabs extending therefrom, said tabs being configured to receive a secondary seal therethrough to provide a tamper indicating function to said locking device when said end pieces are connected together by said locking member.

12. A method of forming and using at least one locking device, said method comprising:
providing a mold with a cavity, said cavity comprising first and second cavity portions interconnected together via at least one connecting cavity portion extending between said first and second cavity portions in said mold;
molding at least one pair of end pieces out of a polymeric material disposed within said cavity, said pair of end pieces comprising first and second end pieces connected together via at least one frangible portion formed by said at least one connecting cavity portion;
providing a locking member;
attaching one end of said locking member to said first end piece;
separating said second end piece from said first end piece by breaking said at least one frangible portion; and
attaching said second end piece to the other end of said locking member when said locking member is inserted through an item to be locked.

13. The method of claim 12, wherein providing a locking member comprises inserting a locking member partially within said first cavity, and wherein attaching one end of said locking member to said first end piece comprises molding said first end piece around said end of said locking member.

14. The method of claim 13 including inserting a locking element at least partially within said second cavity and molding said second end piece around said locking element, said locking element being configured to receive the other end of said locking member therein to secure said second end piece to said locking member.

15. The method of claim 12, wherein said cavity comprises a series of pairs of first and second cavity portions, one of said first and second cavity portions of one pair of cavity portions being interconnected with one of said first and second cavity portions of another pair of cavity portions via at least one other connecting cavity portion.

16. The method of claim 15, wherein molding at least one pair of end pieces comprises molding a series of pairs of first and second end pieces, each pair of first and second end pieces being connected together via at least one frangible portion formed by said at least one connecting cavity portion.

17. The method of claim 16, wherein said first cavity portion of at least some of said pairs being interconnected with said second cavity portion of another of said pairs, such that said first end piece of said at least some of said pairs is connected to a second end piece of another of said pairs via at least one other frangible portion.

18. The method of claim 17, wherein providing a locking member comprises inserting a locking member partially within each of said first cavities, and wherein attaching one end of said locking member to said first end piece comprises molding said first end pieces around said ends of said locking members.

19. The method of claim 16 including separating a pair of first and second end pieces from said series of pairs to provide a single locking device for use.

20. The method of claim 19 including forming matching indicia on said first and second end pieces of each pair of respective end pieces to identify said end pieces of a particular locking device.

21. A series of locking devices comprising:
a series of pairs of end pieces formed together via a forming process, each of said pairs of end pieces comprising first and second end pieces joined together via at least one first frangible portion between said first and second end pieces, said first or second end piece of one pair of said series being joined to said first or second end piece of another pair of said series via at least one second frangible portion between said pairs of end pieces;
a plurality of locking members attached to respective ones of said first end pieces and extending therefrom; and
wherein said pair of first and second end pieces and said respective locking member comprise a locking device, said locking devices being separable from said series via breaking of said at least one second frangible portion between said pairs of end pieces, said second end piece of said locking device being separable from said first end piece and being configured to attach to the other end of said locking member when said locking member is inserted through an object to lock said locking device to the object.

22. The series of locking devices of claim 21, wherein said locking members are insert molded within said respective first end pieces.

23. The series of locking devices of claim 21, wherein said first and second end pieces are formed together via a molding process that forms said first and second end pieces and said first and second frangible portions.

24. The series of locking devices of claim 21, wherein said first and second end pieces are formed with a surface thereon for forming indicia to identify respective pairs of first and second end pieces.

25. The series of locking devices of claim 24, wherein said surface comprises a substantially planar surface for printing or applying indicia thereon.

26. The series of locking devices of claim 24, wherein said surface comprises a roughened surface for printing or applying indicia thereon.

27. The series of locking devices of claim 21, wherein said first and second end pieces of each pair of end pieces include first and second tabs extending therefrom, said tabs being configured to receive a secondary seal therethrough to provide a tamper indicating function to said locking devices when said end pieces are connected together by said locking members.

28. The series of locking devices of claim 27, wherein one of said first and second frangible portions is between said first and second tabs.

29. The series of locking devices of claim 21, wherein at least one of said first and second end pieces includes an identification element for identifying said at least one of said first and second end pieces of a respective one of said locking devices.

30. The series of locking devices of claim 29, wherein said identification element comprises a radio frequency identification chip.
